(19) United States
(12) Patent Application Publication
(10) Pub. No.: US 2005/0238100 A1
(43) Pub. Date: Oct. 27, 2005

(54) Video encoding method for encoding P frame and B frame using I frames

(76) Inventors: Wei-Chuan Hsiao, Hsinchu (TW); Hua-Hsing Hsieh, Hsinchu (TW); Teng-Chou Chang, Hsinchu (TW); Shyh-Liarng Hwang, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/095,839

(22) Filed: Mar. 30, 2005

(30) Foreign Application Priority Data
Apr. 22, 2004 (TW) 93111274

(51) Int. Cl. H04N 7/12

(52) U.S. Cl. 375/240.16; 375/240.12; 375/240.2; 375/240.24; 375/240.15; 375/240.03

(57) ABSTRACT

This invention discloses a video encoding method for encoding P frames and B frames using I frames. The video encoding method includes: I frame encoding process, which generates encoded I frames and compressed I frames by intra encoding; and P and B frame encoding process, which generated encoded P frames and B frames using aforementioned compressed I frames.

### BACKGROUND OF THE INVENTION

a) Field of the Invention

The invention relates to a video encoding method, and more particularly, to a video encoding method using I frames to encode P frames and B frames.

b) Description of the Related Art

Video compact disc (VCD) and digital versatile disc (DVD) are small in size and have great storability, general users are able to make and edit personal VCDs or DVDs for keep or give them away as gifts. Users especially favor DVD due to its' high picture quality and substantial storage size, such characteristics can be used to instantly record television shows. Because of these advantages of digital technologies, VCD and DVD are taking over the traditional videotape market and are widely used by consumers.

VCD and DVD respectively use Moving Picture Experts Group 1 (MPEG) and MPEG 2 video encoding methods as their main format for storing video signals. In the specification written by the National Television Standards Committee (NTSC) adapted by North America and Japan, VCD processes data at a resolution of 352 pixels.times.240 pixels at 29.97 frames per second with up to 58M bps of uncompressed data, whereas DVD processes data at a resolution of 720 pixels.times.480 pixels at 29.97 frames per second with up to 237M bps of uncompressed data. In the specification of Phase Alternating Lines (PAL) adapted by most European countries and Australia, VCD processes data at a resolution of 352 pixels.times.288 pixels at 25 frames per second, with up to 58M bps of uncompressed data; and DVD processes data at a resolution of 720 pixels.times.576 pixels at 25 frames per second, with up to 237M bps of uncompressed data. With such high information traffic, how to accomplish real-time encoding compression becomes an important issue.

FIG. 1 is a schematic diagram illustrating a basic compression format structure according to the specification of MPEG

Referring to FIG. 1, picture 101, 102, 103, or 104 is a unit commonly used in video encoding and varies according to different coding methods. The unit can be intra-coded picture (I frame), predictive coded picture (P frame), or bidirectionally predicted picture (B frame). The pictures 101, 102, 103, and 104 form a group of pictures (GOP). The GOP allows random access to a video sequence 100 formed by a plurality of pictures or GOPs; a film may comprise one video sequence or several video sequences.

The picture 101 has a plurality of slices 105. Each slice 105 sections the picture 101 horizontally and evenly; it's the smallest unit in synchronized signals and error control. The slice 105 has a plurality of macroblocks 106. The macroblocks 106 are basic units of motion prediction and motion compensation, and each of the macroblocks 106 has a plurality of blocks 107. The blocks 107 comprise quantized picture data and each is an 8.times.8 array of pixels. The pictures 102, 103 and 104 have structures similar to that of the picture 101.

According to the standard set by the MPEG committee, there are three types of picture compressions: I frame, P frame, and B frame. I frames are still pictures that are coded without predictions and require the biggest storage space; without I frames, one cannot select scenes freely. Data compression of I frames is completed by discrete cosine transform (DCT). The compression is often done by dividing a whole picture into several small blocks, 8.times.8 or 16.times.16, and DCT is performed to each small block individually, which is similar to the compression of joint photographic experts group (JPEG). Information of reference frames are used to decode P frames; these reference frames are previously-shown I frames or P frames. In addition, motion compensation is used to predict encoding, and so P frames have a higher encoding efficiency. B frames use both previous and future reference frames for decoding; thus B frames have the highest encoding efficiency and are not used for other predictions.

In conventional encoding methods, the encoding speed is very slow due to motion compensation, the complication of search rule, and the encoding of transition effects with changing scenes. Thus, different encoding methods have been developed. One method is to encode with I frames only, reducing the usage of the search rule and motion compensation to enhance the encoding speed; however, this type of encoding method has a low compression ratio, and the video quality is not good. Another method is to edit the search rule and motion compensation operation in P frames and B frames for executing the compression of the two frames, but this method produces low quality video at low bit rate.

In conclusion, it is necessary to develop a new video encoding method that distributes sufficient bits to each macroblock of the P frames and B frames at low bit rate so the good quality and compression rate of the video are maintained.

### SUMMARY

An object of the invention is to provide a new video encoding method that efficiently distributes sufficient bits to each macroblock when P frames and B frames are at lower bit rate to enable speedy coding, during which the quality and compression rate of videos are maintained.

The invention discloses a video encoding method for encoding P frames and B frames using I frames while maintaining fast encoding rate, high compression ratio, and high quality.

The video encoding method for encoding P frames and B frames using I frames includes: I frame encoding process for generating encoded I frames and compressed I frames; P frame and B frame encoding process for generating encoded P frames and B frames using the compressed I frames.

The I frame encoding process includes the following steps: writing null prediction frame parameters into I frame macroblocks; transforming the macroblocks by DCT; giving best parameter values to the macroblocks by using a size-optimization method; transforming the macroblocks by intra quantization; writing null motion vectors of (0,0) into the macroblocks; coding the macroblocks with Huffman coding; outputting encoded I frame and compressed I frame. The size-optimization method further comprises the steps of: calculating the differences between the macroblocks, determining the q ratio of each macroblock, and distributing mquant from MPEG standard mquant table according to the q ratio.

The null prediction frame parameters include motion type, macroblocks type, and DCT type; each is written in addresses: MC_FRAME, MB_INTRA and 0, respectively.

The best parameter values of the macroblocks include: q scale type, mquant, pre mquant, and Q.

The P-frame and B-frame encoding process comprises the step of: writing picture information into macroblocks of P frame or B frame; writing slice information into the macroblocks; writing forward type parameters into the macroblocks; reading the compressed I frame; processing the macroblocks, when processing the first macroblock, use the size-optimization method to give the first macroblock a set of best paramater values, and when processing other macroblocks beside the first macroblock, write the set of best parameter values directly into the macroblocks and set all of the MPEG skip parameters to 1; writing the compressed I frame into the macroblocks of P frames and B frames; writing null motion vectors of (0, 0) into the macroblocks; coding the macroblocks with Huffman coding; and outputting the encoded P frame and B frame. The size-optimization method further comprises the steps of: calculating the differences between the macroblocks, determining the q ratio of the macroblocks, and distributing mquant from standard MPEG mquant table according to the q ratio.

The best parameter values of the macroblocks include: q scale type, mquant, pre mquant, and Q.

By using the method aforementioned, the compressed I frames are outputted directly without going through inverse quantization and inverse DCT; the compressed I frames can be applied to encode P frames and B frames directly. Thus, the encoded P frames and B frames are output without going through operations such as search rule, DCT, quantization, inverse quantization, and inverse DCT. Thereby the encoding is fast, and has good compression ratio and quality.

### BRIEF DESCRIPTION OF THE DRAWINGS

FIG. 1 is a schematic diagram illustrating a basic compression format structure according to the specification of MPEG

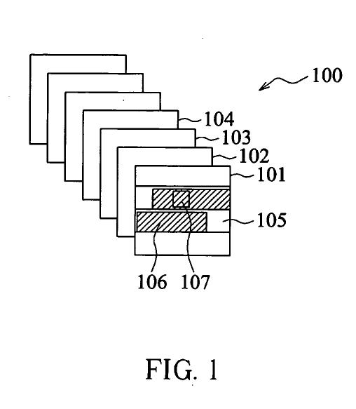

FIG. 2 is a flow chart illustrating an I frame encoding process of the video encoding method according to the embodiment of the invention.

FIG. 3 is a flow chart illustrating an P frame and B frame encoding process of the video encoding method according to the embodiment of the invention.

### DETAILED DESCRIPTION OF THE INVENTION

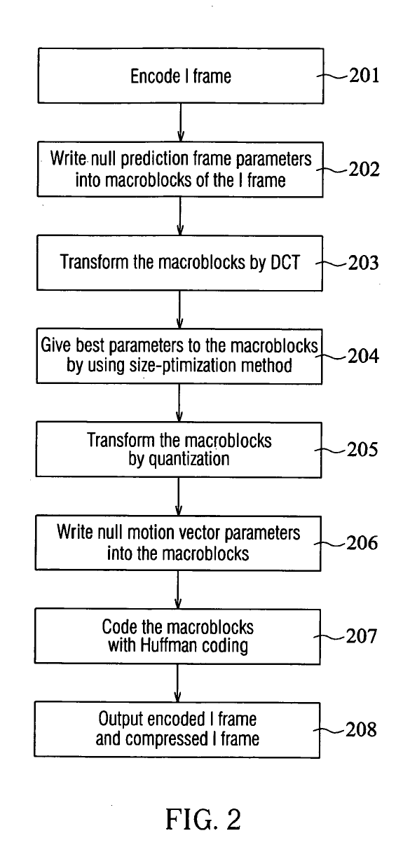

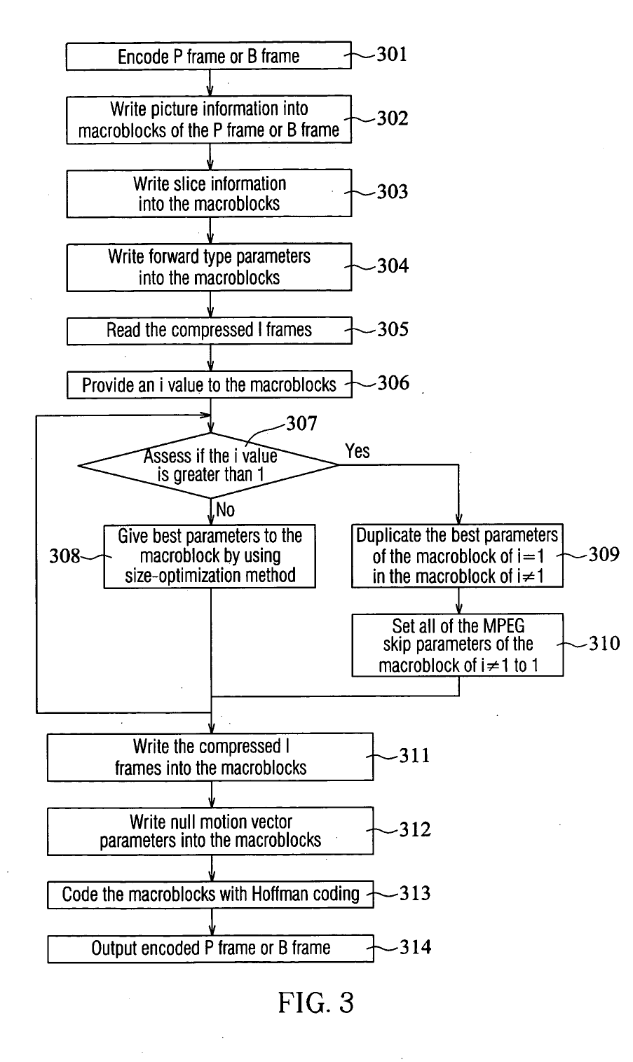

The invention is a video encoding method including an I frame encoding process and a P frame and B frame encoding process as aforementioned. FIG. 2 is used to describe the I frame encoding process; and FIG. 3 is used to describe the P frame and B frame encoding process.

FIG. 2 is a flow diagram showing process steps for encoding I frames according to a preferred embodiment of the invention.

Referring to FIG. 2, I frame is encoded according to the MPEG standard in step 201. In step 202, null prediction frame parameters are written into macroblocks; the parameters include: motion type of the macroblocks, macroblock type, and DCT type, which are respectively written into addresses: MC_FRAME, MB_INTRA, and 0. In step 203, the macroblocks are transformed by DCT to change the spatial signals into cosine signals. In step 204, a set of best parameter values is given to the macroblocks by using a size-optimization method; the best parameter values of the macroblocks include: q scale type, mquant, pre mquant and Q. A high quality of I frames can be obtained according to the best parameter values. The size-optimization method calculates the variances between the macroblocks for determining the q ratio of each macroblock and, distributes mquant from the MPEG standard mquant table to the macroblocks according to the q ratio.

Next, in step 205, each macroblock is transformed by quantization to lower the dynamic region of the value. In Step 206, the null motion vector parameters are written into the macroblocks as a medium for motion compensation; the motion vector is (0, 0) in these macroblocks. Then, in step 207, the macroblocks are coded with Huffman coding; finally, in step 208, the encoded I frame and compressed I frame are output. The compressed I frames are used for encoding and correcting P frames and B frames; the I frame is not only small in size, its quality is also very good. According to the encoding method of I frames described above, all macroblocks in the I frame are intra coded, so the encoding time is reduced due to the fact that the encoded I frame and compressed I frame don't need to go through inverse quantization and inverse DCT before being output.

FIG. 3 is a flow diagram showing process steps for encoding P frames and B frames according to a preferred embodiment of the invention.

Referring to FIG. 3, P frame or B frame is encoded according to the MPEG standard in step 301. In step 302, picture information is written into the macroblocks. In step 303, slice information is written into the macroblocks. In step 304, forward type parameters are written into the macroblocks; the forward type parameters include motion type, macroblock type, and DCT type. Then, the compressed I frames from aforementioned I frame encoding process are read in step 305.

In step 306, an i value is provided as a determiner for processing macroblocks in steps 307 through 310; steps 307 to 310 is a loop, it takes different actions according to different i values wherein the i value represents the macroblock in process. The i value has a starting value of 1 and, its value increases by one every time a macroblock has been processed. In other words, i=1 when the first macroblock is being processed; after it has been processed, the i value increases by one, and thus i=2 when the second macroblock is being processed. The loop continues until the last macroblock has been processed. After an i value has been provided in step 306 as mentioned above, its value is assessed in step 307. If the i value is smaller than 1, proceed to step 308 where a set of best parameter values is given to the macroblock by using the size-optimization method. On the other hand, if the i value is greater than 1 (which is an indication that the macroblock in process is not the first macroblock), proceed to step 309 where the best parameter values of the first macroblock is duplicated in the processing macroblock; then proceed to step 310 where all of the MPEG skip parameters of the macroblock are set to 1. According to the steps described above, the parameters of the macroblocks are not determined repeatedly while processing each macroblock because the information from the first macroblock can be used directly, and thus the encoding speed is enhanced.

After all of the macroblocks have been processed using the aforementioned method, proceed to step 311. In step 311, the compressed I frames read in step 305 are written into the macroblocks of P or B frame. In step 312, the null motion vector parameters are written into the macroblocks; the motion vector is (0,0). In step 313, the macroblocks are coded with Huffman coding. Finally, in step 314, the encoded P or B frame is output.

In the encoding process of the P frames and B frames according to the embodiment of the invention, the compressed I frames are written directly into the P and B frames; therefore, the prediction of P and B frames are not required. Moreover, operations such as search rule, DCT, quantization, inverse quantization, or inverse DCT are omitted as well, in which the omission results in a reduction of encoding space and an increase in the encoding speed.

The video encoding method of the invention has time advantage because not only does the I frame encoding process excludes inverse quantization and inverse DCT, the P frames and B frames are also able to skip operations such as search rule, DCT, quantization, inverse quantization, and inverse DCT and, the information in P frame and B frame macroblocks are not reset repeatedly. In addition, instead of following the standard MPEG process, the encoding of P frames and B frames only involves compressed I frames, which have very small information size, and hence the video encoding method of the invention has high compression ratio. Moreover, since I frames have the best quality according to the MPEG standard and that the P frames and B frames are encoded by using compressed I frames, the P frames and B frames are of high quality as well. In conclusion, the video encoding process for encoding P frames and B frames using I frames according to the invention is able to achieve the objects of having fast speed, high compression ratio, and high quality.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A video encoding method for encoding P frames and B frames using I frames, comprising:
I frame encoding process, which uses intra encoding to generate encoded I frames and compressed I frames; and
P frame and B frame encoding process, which uses the compressed I frames to generate encoded P frames and B frames.

2. The video encoding method for encoding P frames and B frames using I frames as described in claim 1, wherein the I frame encoding process comprises:
writing null prediction frame parameters into macroblocks of the I frame;
transforming the macroblocks by discrete cosine transform;
giving best parameter values to the macroblocks by using a size-optimization method;
transforming the macroblocks by intra quantization;
writing null motion vectors parameters into the macroblocks;
coding the macroblocks with Huffman coding; and
outputting encoded I frame and compressed I frame,
wherein the size-optimization method further comprises: calculating the differences between the macroblocks, determining q ratio of each of the macroblocks, and distributing mquant of MPEG mquant table according to the q ratio.

3. The video encoding method for encoding P frames and B frames using I frames as described in claim 2, wherein the null prediction frame parameters include motion type, macroblock type, and discrete cosine transform type (DCT type).

4. The video encoding method for encoding P frames and B frames using I frames as described in claim 2, wherein the null prediction frame parameters are written in addresses: MC_FRAME, MB_INTRA and 0, respectively.

5. The video encoding method for encoding P frames and B frames using I frames as described in claim 2, wherein the best parameter values of the macroblocks include q scale type, mquant, pre mquant and Q.

6. The video encoding method for encoding P frames and B frames using I frames as described in claim 2, wherein the null motion vector parameters have a motion vector of (0, 0).

7. The video encoding method for encoding P frames and B frames using I frames as described in claim 1, wherein the P frame and B frame encoding process comprises:
writing picture information into macroblocks of the P frame or B frame;
writing slice information into the macroblocks of the P frame or B frame;
writing forward type parameters into the macroblocks;
reading the compressed I frames;
processing the macroblocks, wherein when processing the first macroblock, the size-optimization method is used to give the first macroblock a set of best parameter values, and when processing other macroblocks beside the first macroblock, the best parameter values are written directly into the other macroblocks and the MPEG skip parameters of the other macroblocks are set to one, this act is repeated until all of the macroblocks are processed;
writing compressed I frames into the macroblocks of the P frame or B frame;
writing null motion vector parameters into the macroblocks;
coding the macroblocks with Hoffman coding; and
outputting encoded P frame or B frame,
wherein the size-optimization method comprises: calculating the difference between the macroblocks, determining the q ratio of each of the macroblocks, and distributing the mquant of the MPEG mquant table to the macroblocks according to the q ratios.

8. The video encoding method for encoding P frames and B frames using I frames as described in claim 7, wherein the best parameter values of the macroblocks include q scale type, mquant value, pre mquant value, and Q.

9. The video encoding method for encoding P frames and B frames using I frames as described in claim 7, wherein the forward type parameters include motion type, macroblock type, and DCT type.

10. The video encoding method for encoding P frames and B frames using I frames as described in claim 7, wherein the null motion vector parameters have a motion vector of (0, 0).

11. A video encoding method for encoding P frames and B frames using I frames comprising an I frame encoding process and a P frame and B frame encoding process, wherein the I frame encoding process comprises:
writing null prediction frame parameters into macroblocks of the I frame;
transforming the macroblocks by discrete cosine transform;
giving best parameter values to the macroblocks by using a size-optimization method;
transforming the macroblocks by intra quantization;
writing null motion vector parameters into the macroblocks;
coding the macroblocks with Huffman coding; and
outputting encoded I frame and compressed I frame, the compressed I frames being used in the P frame and B frame encoding process;
wherein the P frame and B frame encoding process comprises:
writing picture information into macroblocks of the P frame or B frame;
writing slice information into the macroblocks of the P frame or B frame;
writing forward type parameters into the macroblocks;
reading the compressed I frames;
processing the macroblocks, wherein when processing the first macroblock, the size-optimization method is used to give the first macroblock a set of best parameter values, and when processing other macroblocks beside the first macroblock, the best parameter values are written directly into the other macroblocks and all of the MPEG skip parameters are set to one;
writing the compressed I frames into the macroblocks of the P frame or B frame;
writing the null motion vector parameters into the macroblocks;
coding the macroblocks with Huffman coding; and
outputting encoded P frame or B frame,
wherein the size-optimization method further comprises the following steps: calculating the differences between the macroblocks, determining the q ratio of each macroblock, and distributing the mquant of MPEG mquant table to the macroblocks according to the q ratio.

12. The video encoding method for encoding P frames and B frames using I frames as described in claim 11, wherein the null prediction frame parameters include motion type, macroblock type, and DCT type.

13. The video encoding method for encoding P frames and B frames using I frames as described in claim 11, wherein the null prediction frame parameters are written in addresses: MC_FRAME, MB_INTRA and 0, respectively.

14. The video encoding method for encoding P frames and B frames using I frames as described in claim 11, wherein the best parameter values of the macroblocks include q scale type, mquant value, pre mquant value, and Q.

15. The video encoding method for encoding P frames and B frames using I frames as described in claim 11, wherein the forward type parameters include motion type, macroblock type, and DCT type.

16. The video encoding method for encoding P frames and B frames using I frames as described in claim 11, wherein the null motion vector parameters have a motion vector of (0,0).
